(19) United States
(12) Patent Application Publication
(10) Pub. No.: US 2024/0237148 A1
(43) Pub. Date: Jul. 11, 2024

(54) HEATER CONTROL SYSTEM

(71) Applicant: Panasonic Automotive Systems Co., Ltd., Kanagawa (JP)

(72) Inventor: Hiroshi ISONO, Kanagawa (JP)

(21) Appl. No.: 18/612,754

(22) Filed: Mar. 21, 2024

Related U.S. Application Data
(63) Continuation of application No. PCT/JP2022/028870, filed on Jul. 27, 2022.

(30) Foreign Application Priority Data
Sep. 27, 2021 (JP) 2021-156945
Apr. 20, 2022 (JP) 2022-069319

(51) Int. Cl. H05B 1/02; H02M 1/00

(52) U.S. Cl. CPC H05B 1/0238; H02M 1/0003

(57) ABSTRACT

A heater control system includes: a resistance heater; and a boost converter that is electrically connected to the resistance heater. The boost converter outputs, to the resistance heater, a boost voltage that is higher than a power supply voltage of a power source that is electrically connected to the boost converter.

### CROSS REFERENCE TO RELATED APPLICATIONS

This is a continuation application of PCT International Application No. PCT/JP2022/028870 filed on Jul. 27, 2022, designating the United States of America, which is based on and claims priority of Japanese Patent Application No. 2021-156945 filed on Sep. 27, 2021 and Japanese Patent Application No. 2022-069319 filed on Apr. 20, 2022.

### FIELD

The present disclosure relates to a heater control system including a heater that heats, for example, a seat provided in a vehicle.

### BACKGROUND

Patent Literature (PTL) 1 discloses a vehicular power source device. This vehicular power source device includes a pulse width modulation (PWM) means and a detection means. The PWM means performs PWM control on power supplied from an in-vehicle power supply to an electrical load, such as a seat heater. The detection means detects by chronologically sampling the voltage value of the in-vehicle power supply at a predetermined period. This vehicular power source device determines the duty ratio of PWM control based on the voltage value detected by the detection means.

### CITATION LIST

### Patent Literature

PTL 1: Japanese Unexamined Patent Application Publication No. 2010-95100

### SUMMARY

However, the vehicular power source device according to PTL 1 can be improved upon.

In view of this, the present disclosure provides a heater control system capable of improving upon the above related art.

A heater control system according to one aspect of the present disclosure includes: a resistance heater; and a boost converter that is electrically connected to the resistance heater. The boost converter outputs, to the resistance heater, a boost voltage that is higher than a power supply voltage of a power source that is electrically connected to the boost converter.

The heater control system according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view of a seat including a heater control system according to an embodiment.

FIG. 2 is a diagram illustrating an overview of the heater control system according to the embodiment.

FIG. 3 is a circuit diagram illustrating an example of a boost converter of the heater control system according to the embodiment.

FIG. 4 is a flowchart illustrating an example of the operations of the heater control system according to the embodiment.

FIG. 5 is a diagram illustrating an overview of a heater control system according to a comparative example.

### DESCRIPTION OF EMBODIMENT

A heater control system according to one aspect of the present disclosure includes: a resistance heater; and a boost converter that is electrically connected to the resistance heater. The boost converter outputs, to the resistance heater, a boost voltage that is higher than a power supply voltage of a power source that is electrically connected to the boost converter.

With this, it is possible to supply power equivalent to rated power of the resistance heater by simply applying relatively small current to the resistive heater. Therefore, there is room to increase the resistance value of the resistance heater. Therefore, when a resistance heater includes stranded wires, the number of stranded wires can be reduced compared with when the resistance value of the resistance heater is reduced. Therefore, the weight of the resistance heater can be reduced and also the cost of manufacturing the resistance heater can be reduced. In other words, the cost and weight of the resistance heater can be easily reduced.

In the heater control system according to another aspect of the present disclosure, the boost voltage is at least two times the power supply voltage.

With this, the resistance value of the resistance heater can be relatively increased. Therefore, even when the boost converter does not work properly (for example, the boost converter has a short circuit fault) and the power supply voltage is applied to the resistance heater, the electric current flowing through the resistance heater can be greatly suppressed. Therefore, it is advantageous in that the possibility of the heater becoming too warm can be reduced without a safety device such as a breaker, and the cost and the weight can be further reduced easily.

The heater control system according to another aspect of the present disclosure further includes a temperature detector that detects a temperature of the resistance heater. The boost converter controls the boost voltage based on a temperature detected by the temperature detector.

This is advantageous in that the temperature at a location where the resistance heater is provided can be accurately controlled easily.

In the heater control system according to another aspect of the present disclosure, when the temperature detected by the temperature detector exceeds a first threshold temperature, the boost converter stops outputting of the boost voltage to the resistance heater. When the temperature detected by the temperature detector falls below a second threshold temperature that is lower than the first threshold temperature, the boost converter starts the outputting of the boost voltage to the resistance heater.

With this, the temperature at a location where the resistance heater is provided can be controlled by only repeating alternately the driving and stopping of the boost converter whose boost voltage is a constant voltage. Therefore, it is advantageous in that another voltage detection circuit will not be needed and it is sufficient to have a simple configuration and control, compared with when the boost voltage is controlled to vary.

In the heater control system according to another aspect of the present disclosure, the boost converter includes an inductance element, a first switching element, a second switching element, and a controller. The inductance element is electrically connected to a positive electrode of the power source. The first switching element is electrically connected between the inductance element and a negative electrode of the power source. The second switching element is electrically connected between the inductance element and the resistance heater. The controller controls on and off of the first switching element and the second switching element. The controller keeps both the first switching element and the second switching element off to stop the outputting of the boost voltage to the resistance heater.

With this, the current flowing path that passes through the boost converter can be interrupted by turning both the first switching element and the second switching element off. Therefore, the current will not continue to flow through the resistance heater, and it is advantageous in that the power consumption can be reduced.

In the heater control system according to another aspect of the present disclosure, the temperature detector operates based on the power supply voltage. First wiring that connects the temperature detector and the boost converter and second wiring that connects the boost converter and the resistance heater belong to mutually different systems.

This is advantageous in that even when current leakage occurs in one of first wiring or second wiring, a possibility that the current leaks to another wiring can be reduced.

In the heater control system according another aspect of the present disclosure, the resistance heater includes a sewed heater wire including a plurality of stranded wires.

This is advantageous in that the resistance value of resistance heater 1 can be easily increased, because the durability of the heater wire is easily secured sufficiently even when the number of stranded wires included in the heater wire is reduced.

In the heater control system according to another aspect of the present disclosure, the resistance heater has a resistance value that increases as a boost ratio increases, the boost ratio being a ratio of the boost voltage to the power supply voltage.

With this, the current value when the resistance heater generates heat with predetermined power can be lowered. Therefore, since the resistance value of the resistance heater can be increased, the number of stranded wires included in the heater wire can be reduced. Consequently, it is advantageous in that material used for the resistance heater can be reduced, and the cost and the weight can be reduced by the amount of the reduced material.

In the heater control system according to another aspect of the present disclosure, the resistance heater is of a single type regardless of a heat generation power specification, and the boost voltage is adjusted based on the heat generation power specification of the resistance heater.

With this, the same resistance heater can support various types of heat generation power specifications. Therefore, it is advantageous in that designing the resistance heater according to specifications will not be needed.

The following specifically describes an embodiment with reference to the drawings.

Note that the embodiment described below merely shows a general or specific example. The numerical values, shapes, materials, structural elements, arrangement and connection of the structural elements, steps, order of the steps, etc., indicated in the following embodiment are given merely by way of illustration and are not intended to limit the present disclosure. Furthermore, among structural elements in the following embodiment, those not recited in any of the independent claims defining the broadest inventive concept are described as optional structural elements.

Moreover, the figures are schematic views and are not necessarily precise illustrations. Furthermore, in the figures, the same reference sign is given to substantially identical elements.

### EMBODIMENT

### Configuration

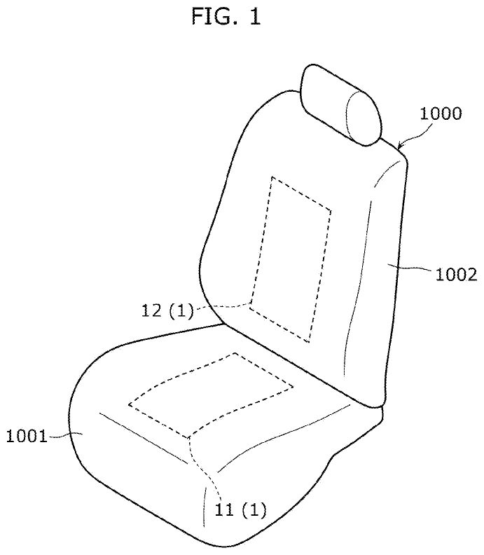

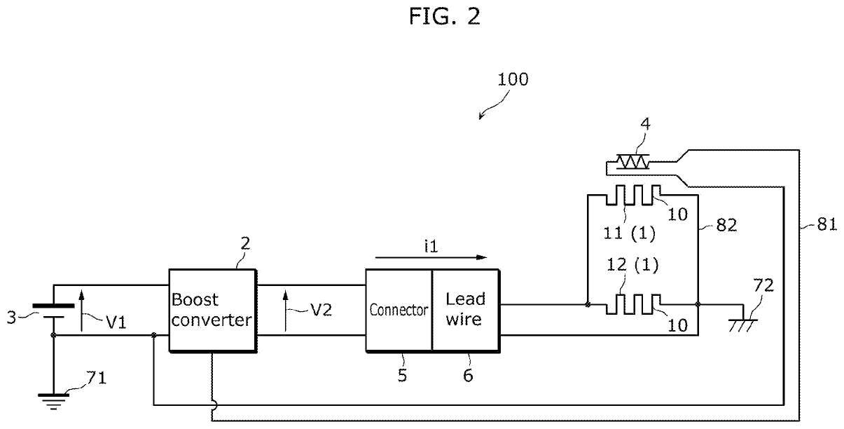

FIG. 1 is a perspective view of a seat including a heater control system according to an embodiment. FIG. 2 is a diagram illustrating an overview of heater control system 100 according to the embodiment. The heater control system is provided in seat 1000 illustrated in FIG. 1 of a movable object. The heater control system is for warming at least part of the body of a user with heat generated by resistance heater 1 provided to each of seating surface 1001 and backrest 1002 of seat 1000 (resistance heater 1 is cushion heater 11 disposed in seating surface 1001 or back heater 12 disposed in backrest 1002), when the user sits The movable object is, for example, an on seat 1000. automobile, but may be other movable objects such as an aircraft or a ship. As illustrated in FIG. 2, heater control system 100 includes two resistance heaters 1, boost converter 2, and temperature detector 4. Note that in the embodiment, heater control system 100 includes temperature detector 4 as a structural element, but does not need to include temperature detector 4 as a structural element.

Each of the two resistance heaters 1 is a wire heater, and includes a base material, heater wire 10, and sewing thread. The base material includes a cloth-shaped foamable resin, such as urethane, which is obtained by forming a sheet with an elastic and ductile material. Note that the base material may be nonwoven fabric. Heater wire 10 is an electrically conductive wire that can generate heat when heater wire 10 is connected to boost converter 2 via connector 5 and lead wire 6 (harness) and current is applied from boost converter 2.

Heater wire 10 is sewed to a surface of the base material to extend from lead wire 6, which is to supply power to heater wire 10, pass through a plurality of portions of the base material, and return to lead wire 6. Heater wire 10 is a metal wire, such as a copper wire, and includes a plurality of stranded wires. For example, heater wire 10 is sewed to a surface of the base material by using thread of polyester fiber as sewing thread. The sewing thread is thread for sewing heater wire 10 to the base material in a direction in which heater wire 10 extends in order to fix heater wire 10 to the base material. In other words, in the embodiment, resistance heater 1 includes sewed heater wire 10 including a plurality of stranded wires. Note that heater wire 10 may be fixed to the base material in a way different from by using sewing thread, for example, by adhesion.

One resistance heater 1, which is one of the two resistance heaters 1, is cushion heater 11 provided to a seat cushion which is a seating part of a seat that supports the buttocks and the femoral region of a user sitting on the seat. More specifically, cushion heater 11 is provided in the seat cushion between a pad, which corresponds to cushion material, and a cover that covers the pad. Cushion heater 11 generates heat by receiving power from boost converter 2 and warms the user via the seat cushion.

The other resistance heater 1, which is the other one of the two resistance heaters 1, is back heater 12 provided to a seat back which is a backrest that supports the back of the user sitting on the seat. More specifically, back heater 12 is provided in the seat back between a pad, which corresponds to cushion material, and a cover that covers the pad. Back heater 12 generates heat by receiving power from boost converter 2 and warms the user via the seat back.

Boost converter 2 is electrically connected to the two resistance heaters 1 via connector 5 and lead wire 6. In the embodiment, the two resistance heaters 1 are connected in parallel to boost converter 2. More specifically, an end of each of the two resistance heaters 1 is electrically connected to lead wire 6, and the other end of each of the two resistance heaters 1 is electrically connected to ground 72. Ground 72 is, for example, a chassis ground, but may be shared with ground 71 on the power source 3 side.

Boost converter 2 is a DC/DC converter. Power source 3 is electrically connected to the input terminal of boost converter 2, and each of the two resistance heaters 1 is electrically connected to the output terminal of boost converter 2 via connector 5 and lead wire 6. Boost converter 2 boosts direct current voltage input from power source 3, and outputs the boost voltage to each of resistance heaters 1 via connector 5 and lead wire 6. In other words, boost converter 2 outputs, to each of resistance heaters 1, boost voltage V2 that is higher than power supply voltage V1 of power source 3 that is electrically connected to boost converter 2.

Power source 3 is, for example, an in-vehicle battery, and supplies power to an electric device such as boost converter 2 provided in the movable object. In the embodiment, power supply voltage V1 is, for example, approximately ten-odd volts. Moreover, boost voltage V2 is, for example, approximately several tens of volts. In other words, in the embodiment, boost voltage V2 is at least two times power supply voltage V1. Note that the upper limit of boost voltage V2 is determined, for example, based on the power that can be output by boost converter 2. In the embodiment, the upper limit of boost voltage V2 is 48 V as an example.

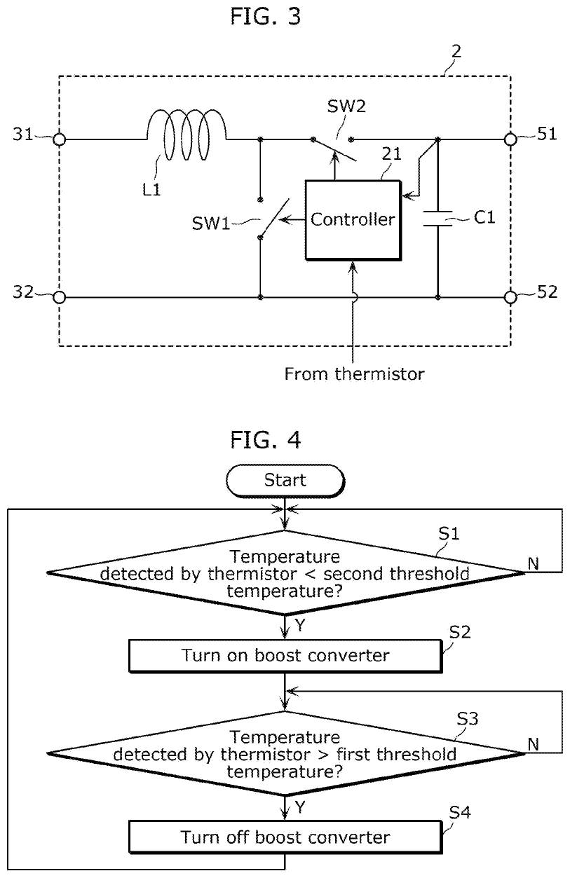

FIG. 3 is a circuit diagram illustrating an example of boost converter 2 of heater control system 100 according to the embodiment. As illustrated in FIG. 3, boost converter 2 includes inductance element L1, first switching element SW1, second switching element SW2, capacitive element C1, and controller 21.

Inductance element L1 includes an end electrically connected to positive electrode 31 of power source 3, and the other end electrically connected to first switching element SW1 and second switching element SW2.

First switching element SW1 and second switching element SW2 are semiconductor switching elements such as a field effect transistor (FET), and switch between on and off by being controlled by controller 21.

First switching element SW1 includes an end electrically connected to inductance element L1, and the other end electrically connected to negative electrode 32 of power source 3 and low-voltage side terminal 52 of connector 5. In other words, first switching element SW1 is electrically connected between inductance element L1 and negative electrode 32 of power source 3. Negative electrode 32 of power source 3 is electrically connected to ground 71.

Second switching element SW2 includes an end electrically connected to inductance element L1, and the other end electrically connected to capacitive element C1 and high-voltage side terminal 51 of connector 5. In other words, second switching element SW2 is electrically connected between inductance element L1 and resistance heater 1.

Capacitive element C1 is electrically connected between high-voltage side terminal 51 and low-voltage side terminal 52 of connector 5. The voltage between the two terminals of capacitive element C1 is output as boost voltage V2 to each of resistance heaters 1 via connector 5 and lead wire 6.

Controller 21 is, for example, an electronic control unit (ECU) to control the two resistance heaters 1. Controller 21 provides a driving signal to each of first switching element SW1 and second switching element SW2 to control on and off of first switching element SW1 and second switching element SW2.

In the embodiment, controller 21 can execute two operations, which are a boosting operation of boost converter 2 and a stopping operation of boost converter 2. In the boosting operation, controller 21 performs PWM control to cause first switching element SW1 and second switching element SW2 to alternately switch on and off. In other words, controller 21 performs PWM control on first switching element SW1 and second switching element SW2 such that when first switching element SW1 is on, second switching element SW2 is off, and when first switching element SW1 is off, second switching element SW2 is on. With this, boost converter 2 outputs boost voltage V2, which is boosted power supply voltage V1, to each of resistance heaters 1 while performing the boosting operation. The boost ratio in the boosting operation is determined based on a duty ratio in the PWM control for first switching element SW1 and second switching element SW2.

In the stopping operation, controller 21 keeps both first switching element SW1 and second switching element SW2 off to stop the outputting of boost voltage V2 to each of resistance heaters 1. Whether controller 21 performs the boosting operation of boost converter 2 or the stopping operation of boost converter 2 is determined based on a temperature detected by temperature detector 4, which will be described later. In other words, in the embodiment, boost converter 2 controls boost voltage V2 based on a temperature detected by temperature detector 4.

Here, the meaning of “controls boost voltage V2” also includes causing boost voltage V2 to be zero, i.e., causing boost converter 2 to stop. Moreover, boost voltage V2 when boost converter 2 performs the boosting operation is a constant voltage.

Temperature detector 4 is provided to resistance heater 1, and detects a temperature at a location where temperature detector 4 is provided, i.e., a temperature of resistance heater 1. In the embodiment, temperature detector 4 is provided to cushion heater 11, which is one of the two resistance heaters 1. Note that temperature detector 4 may be provided to back heater 12, instead of cushion heater 11.

In the embodiment, temperature detector 4 is a thermistor, and includes an end electrically connected to controller 21 of boost converter 2, and the other end electrically connected to ground 71. Controller 21 operates by receiving power supplied from power source 3, and therefore temperature detector 4 also operates by receiving power supplied from power source 3 as with controller 21. In other words, temperature detector 4 operates based on power supply voltage V1.

Here, first wiring 81 that connects temperature detector 4 and boost converter 2 receives power supply voltage V1, and is wiring that receives a relatively lower voltage. In contrast, second wiring 82 that connects boost converter 2 and each of resistance heaters 1 receives boost voltage V2, and is wiring that receives a relatively higher voltage. Accordingly, in the embodiment, first wiring 81 and second wiring 82 belong to mutually different systems. Therefore, even when current leakage occurs in one of first wiring 81 or second wiring 82, a possibility that the current leaks to the other wiring can be reduced.

Next, an example of setting a resistance value of heater wire 10 will be described.

Boost ratio K, which is a ratio of boost voltage V2 to power supply voltage V1, is expressed by the following equation (1).

$$K = V 2 / V 1 \qquad ( 1 )$$

Moreover, power W when heater wire 10 generates heat is expressed by the following equation (2), by using resistance value R which is obtained by combining the resistance value of cushion heater 11 and the resistance value of back heater 12 in heater wire 10.

$$W = V {2}^{2} / R \qquad ( 2 )$$

According to equations (1) and (2), resistance value R of heater wire 10 is expressed by the following equation (3).

$$R = K 2 \cdot V {1}^{2} / W \qquad ( 3 )$$

Here, when a necessary amount of heat generation is determined, if power W is constant and power supply voltage V1 is constant because power supply voltage V1 is a voltage of power source 3 (battery), according to equation (3), resistance value R of heater wire 10 is proportional to K2. Now, if boost ratio K is increased by two times, resistance value R becomes 22, which is equal to four times.

In this manner, resistance value R can be obtained by equation (3) based on boost ratio K of boost converter 2. Here, boost ratio K is greater than 1 because boosting of the voltage is assumed. Therefore, resistance value R obtained by equation (3) is greater than the resistance value when boost ratio K is 1. Based on these, resistance heater 1 has resistance value R that increases as boost ratio K increases, boost ratio K being a ratio of boost voltage V2 to power supply voltage V1.

### <Operations>

The following describes operations of heater control system 100 according to the embodiment, with reference to FIG. 4. FIG. 4 is a flowchart illustrating an example of the operations of heater control system 100 according to the embodiment. The operations of heater control system 100 will start, for example, when a user turns on the power of heater control system 100.

Controller 21 repeats steps S1 to S4 during operation of heater control system 100. In other words, when boost converter 2 performs the stopping operation, i.e., boost converter 2 is off, each of resistance heaters 1 is in an off state. Therefore, the temperature detected by temperature detector 4 (here, thermistor) decreases over time. Controller 21 maintains the stopping operation of boost converter 2 until the temperature detected by temperature detector 4 falls below a lower limit temperature (second threshold temperature) (No in step S1). In contrast, controller 21 starts the boosting operation of boost converter 2, i.e., turns on boost converter 2 (step S2), when the temperature detected by temperature detector 4 falls below the lower limit temperature (Yes in step S1). With this, each of resistance heaters 1 becomes in an on state, and the temperature detected by temperature detector 4 increases over time.

Controller 21 maintains the boosting operation of boost converter 2 until the temperature detected by temperature detector 4 exceeds an upper limit temperature (first threshold temperature) (No in step S3). In contrast, controller 21 starts the stopping operation of boost converter 2, i.e., turns off boost converter 2 (step S4), when the temperature detected by temperature detector 4 exceeds the upper limit temperature (Yes in step S3).

As described above, controller 21 repeats turning on and off each of resistance heaters 1 by repeating the boosting operation and the stopping operation of boost converter 2 so that the temperature detected by temperature detector 4 falls between the upper limit temperature and the lower limit temperature, inclusive. With this, the temperature detected by temperature detector 4 is maintained at an approximately constant temperature. Note that two different threshold temperatures are set as the lower limit temperature when each of resistance heaters 1 is in an off state and the upper limit temperature when each of resistance heaters 1 is in an on state. This prevents chattering from occurring when each of resistance heaters 1 is turned on and off. A temperature difference between the lower limit temperature and the upper limit temperature is, for example, 1 degree Celsius.

### <Comparison>

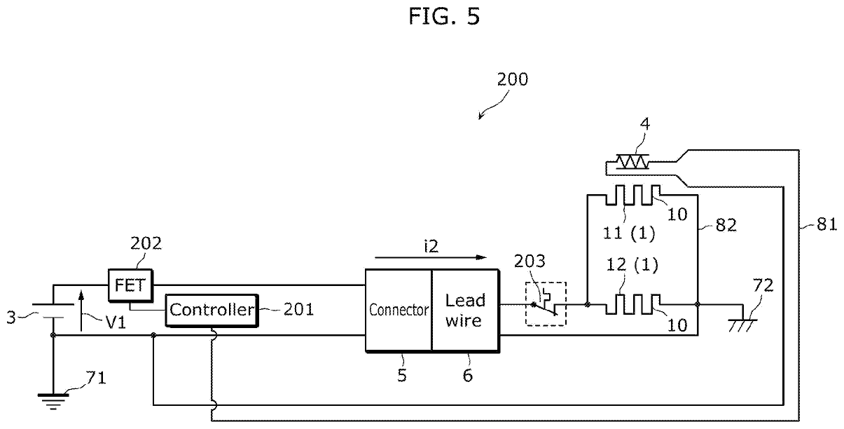

The following describes advantages of heater control system 100 according to the embodiment in comparison with heater control system 200 according to a comparative example illustrated in FIG. 5. FIG. 5 is a diagram illustrating an overview of heater control system 200 according to the comparative example. Heater control system 200 according to the comparative example is different from heater control system 100 according to the embodiment in that heater control system 200 does not include boost converter 2, and includes controller 201, FET 202, and breaker 203.

Controller 201 is, for example, an ECU to control, for example, two resistance heaters 1, as with controller 21. FET 202 is a field-effect transistor, and electrically connected between positive electrode 31 of power source 3 and connector 5. Controller 201 controls on and off of FET 202 by providing a driving signal to FET 202. In heater control system 200 according to the comparative example, when FET 202 is in an on state, power is supplied from power source 3 to each of resistance heaters 1 via connector 5 and lead wire 6, and each of resistance heaters 1 is turned on. Moreover, when FET 202 is in an off state, the current flowing path between power source 3 and connector 5 is interrupted, the power is not supplied to each of resistance heaters 1, and thus resistance heaters 1 are turned off.

In other words, in heater control system 200 according to the comparative example, FET 202 repeats turning on and off instead of boost converter 2 repeating the boosting operation and the stopping operation. With this, the temperature detected by temperature detector 4 is maintained at an approximately constant temperature as with the embodiment.

Breaker 203 is electrically connected between lead wire 6 and resistance heaters 1 and configured to interrupt the current flowing path when current greater than or equal to a predetermined magnitude continues to flow. This prevents excessive current from continuing to flow into each of resistance heaters 1.

Here, since heater control system 200 according to the comparative example does not include boost converter 2, when FET 202 is an on state, power supply voltage V1 of power source 3 is applied to each of resistance heaters 1 via connector 5 and lead wire 6. Therefore, it is necessary to apply relatively large current i2 to each of resistance heaters 1 to supply power that corresponds to the rated power (for example, several tens of watts) to each of resistance heaters 1. In order to apply relatively large current i2 to each of resistance heaters 1, the resistance value of each of resistance heaters 1 should be reduced to a relatively small value. Note that current i2 mentioned here means a sum of the current flowing through resistance heaters 1. Therefore, the current flowing through cushion heater 11 and the current flowing through back heater 12 become both smaller than current i2.

A possible way to reduce the resistance value of each of resistance heaters 1 is to increase the number of stranded wires included in heater wire 10 of each of resistance heaters 1. However, since the weight of heater wire 10 increases as the number of stranded wires increases, consequently, the weight of each of resistance heaters 1 increases. Moreover, since the number of stranded wires included in heater wire 10 increases, consequently, the cost of manufacturing each of resistance heaters 1 increases.

In view of the above, heater control system 100 according to the embodiment aims to solve the above problems by including boost converter 2. In other words, heater control system 100 includes boost converter 2, and thus boost voltage V2, which is boosted voltage of power supply voltage V1 of power source 3, is applied to each of resistance heaters 1 via connector 5 and lead wire 6. Therefore, heater control system 100 according to the embodiment can supply power that corresponds to the rated power to each of resistance heaters 1 by only applying small current i1 (<i2) to each of resistance heaters 1, compared with heater control system 200 according to the comparative example. Since it is sufficient to apply relatively small current i1 to resistance heaters 1, there is room to increase the resistance value of each of resistance heaters 1 compared with heater control system 200 according to the comparative example. Note that current i1 mentioned here means a sum of the current flowing through resistance heaters 1. Therefore, the current flowing through cushion heater 11 and the current flowing through back heater 12 become both smaller than current i1.

Therefore, since heater control system 100 according to the embodiment does not have a problem even when the resistance value of each of resistance heaters 1 increases, the number of stranded wires included in heater wire 10 can be reduced compared with heater control system 200 according to the comparative example. As a result, in heater control system 100 according to the embodiment, the weight of heater wire 10 can be reduced compared with heater control system 200 according to the comparative example, and consequently, the weight of each of resistance heaters 1 can be reduced. Moreover, since the number of stranded wires included in heater wire 10 is reduced, consequently, the cost of manufacturing each of resistance heaters 1 can be reduced. As described above, heater control system 100 according to the embodiment advantageous in that the cost and the weight can be easily reduced.

Moreover, in heater control system 100 according to the embodiment can further obtain the following advantages depending on the boost ratio of boost converter 2. In other words, when boost voltage V2 output from boost converter 2 is at least 1.5 times, preferably at least 2 times power supply voltage V1, a possibility of the seat becoming too warm can be reduced without breaker 203, and the cost and the weight can be further reduced easily.

This is because in heater control system 200 according to the comparative example, the resistance value of each of resistance heaters 1 has to be reduced to a relatively low value. Therefore, for example, when power supply voltage V1 continues to be applied to each of resistance heaters 1, for instance, due to failure of FET 202, each of resistance heaters 1 is likely to be too warm. For this reason, heater control system 200 according to the comparative example provides breaker 203 to reduce the possibility of the seat being too warm.

In contrast, heater control system 100 according to the embodiment can increase the resistance value of each of resistance heater 1 relatively high, even when boost converter 2 does not operate properly and power supply voltage V1 continues to be applied to each of resistance heaters 1, the current flowing through each of resistance heaters 1 further reduces from the current when boost voltage V2 is applied. Based on the above, if power supply voltage V1 is less than or equal to half power supply voltage V2, the current flowing through each of resistance heater 1 is greatly suppressed, and thus each of resistance heaters 1 will not be too warm. Therefore, breaker 203 will not be needed.

Moreover, in heater control system 100 according to the embodiment, each of resistance heaters 1 includes sewed heater wire 10 including a plurality of stranded wires. Therefore, the above-described advantage can be further obtained. In other words, for example, when heater wire 10 is a solid wire and sewed to the base material, heater wire 10 has to be made thin in order to increase the resistance value of heater wire 10. In this case, if each of resistance heaters 1 is formed by, for example, pressure bonding the thinned heater wire 10 to the base material without sewing, heater wire 10 would be, for example, bended by the stress applied when a user sits on the seat, thereby making it difficult to ensure durability of heater wire 10.

In contrast, in heater control system 100 according to the embodiment, each of resistance heaters 1 includes sewed heater wire 10 including a plurality of stranded wires. Therefore, even when the number of stranded wires is reduced to increase the resistance value of heater wire 10, a sufficient durability can be easily secured with respect to the stress to be applied when a user sits on the seat. Therefore, heater control system 100 according to the embodiment is advantageous in that the resistance value of resistance heater 1 can be easily increased while sufficiently securing the durability of heater wire 10.

Note that since boost converter 2 has a feature of being able to adjusting boost voltage V2, resistance heaters 1 of only a single type may be prepared for heater control system 100 regardless of a heat generation power specification needed for each of resistance heaters 1 by taking advantage of this feature. Heater control system 100 may have a configuration that corresponds to the heat generation power specification needed for adjustment of boost voltage V2. A specific example of this configuration will be described below. First, according to equations (1) and (2), power W when heater wire 10 generates heat is expressed by the following equation (4).

$$W = K 2 \cdot V {1}^{2} / R \qquad ( 4 )$$

Here, since resistance heaters 1 is of a single type, resistance value R is constant. Moreover, as described above, since power supply voltage V1 is constant, V1²/R in equation (4) will be constant and power W is proportional to K2. For example, based on the heat generation power specification necessary for each of resistance heaters 1, when the amount of heat generation (=power W) needs to be increased by 10%, boost ratio K may be increased by approximately 1.05 times (=√(1+0.1)). Therefore, according to equation (1), power supply voltage V1 is constant, and thus boost voltage V2 only needs to be adjusted to approximately 1.05 times the present boost voltage V2.

### <Working Effects>

As described above, heater control system 100 according to the embodiment includes: resistance heater 1; and boost converter 2 that is electrically connected to resistance heater 1. Boost converter 2 outputs, to resistance heater 1, boost voltage V2 that is higher than power supply voltage V1 of power source 3 that is electrically connected to boost converter 2.

With this, power corresponding to the rated power of resistance heater 1 can be supplied only by applying relatively small current to resistance heater 1. Therefore, there is room to increase the resistance value of resistance heater 1. Accordingly, when resistance heater 1 includes stranded wires, the number of stranded wires can be reduced compared with when the resistance value of the resistance heater is reduced. Therefore, the weight of resistance heater 1 can be reduced and also the cost of manufacturing resistance heater 1 can be reduced. In other words, the cost and weight of resistance heater 1 can be easily reduced.

Moreover, in heater control system 100 according to the embodiment, boost voltage V2 is at least two times power supply voltage V1.

With this, the resistance value of resistance heater 1 can be relatively increased. Therefore, even when boost converter 2 does not work properly (for example, the boost converter has a short circuit fault) and power supply voltage V1 is applied to resistance heater 1, the electric current flowing through resistance heater 1 can be greatly suppressed. Therefore, it is possible to reduce the possibility of the heater becoming too warm without a safety device such as breaker 203, and the cost and the weight can be further reduced easily.

Moreover, heater control system 100 according to the embodiment further includes temperature detector 4 that detects a temperature of resistance heater 1. Boost converter 2 controls boost voltage V2 based on a temperature detected by temperature detector 4.

This is advantageous in that the temperature at a location where resistance heater 1 is provided can be accurately controlled easily.

Moreover, in heater control system 100 according to the embodiment, when the temperature detected by temperature detector 4 exceeds a first threshold temperature, boost converter 2 stops outputting of boost voltage V2 to resistance heater 1. When the temperature detected by temperature detector 4 falls below a second threshold temperature that is lower than the first threshold temperature, boost converter 2 starts the outputting of boost voltage V2 to resistance heater 1.

With this, the temperature at a location where resistance heater 1 is provided can be controlled by only repeating alternately the driving and stopping of boost converter 2 whose boost voltage V2 is a constant voltage. Therefore, it is advantageous in that another voltage detection circuit will not be needed and it is sufficient to have a simple configuration and control, compared with when boost voltage V2 is controlled to vary.

Moreover, heater control system 100 according to the embodiment, boost converter 2 includes inductance element L1, first switching element SW1, second switching element SW2, and controller 21. Inductance element L1 is electrically connected to positive electrode 31 of power source 3. First switching element SW1 is electrically connected between inductance element L1 and negative electrode 32 of power source 3. Second switching element SW2 is electrically connected between inductance element L1 and resistance heater 1. Controller 21 controls on and off of first switching element SW1 and second switching element SW2. Controller 21 keeps both first switching element SW1 and second switching element SW2 off to stop the outputting of boost voltage V2 to resistance heater 1.

With this, the current flowing path that passes through boost converter 2 can be interrupted by turning both first switching element SW1 and second switching element SW2 off. Therefore, the current will not continue to flow through resistance heater 1, and it is advantageous in that the power consumption can be reduced.

Moreover, in heater control system 100 according to the embodiment, temperature detector 4 operates based on power supply voltage V1. First wiring 81 that connects temperature detector 4 and boost converter 2 and second wiring 82 that connects boost converter 2 and resistance heater 1 belong to mutually different systems.

This is advantageous in that even when current leakage occurs in one of first wiring 81 or second wiring 82, a possibility that the current leaks to another wiring can be reduced.

Moreover, in heater control system 100 according to the embodiment, resistance heater 1 includes sewed heater wire 10 including a plurality of stranded wires.

This is advantageous in that the resistance value of resistance heater 1 can be easily increased, because the durability of heater wire 10 is easily secured sufficiently even when the number of stranded wires included in heater wire 10 is reduced.

Moreover, in heater control system 100 according to the embodiment, resistance heater 1 has resistance value R that increases as boost ratio K increases, boost ratio K being a ratio of boost voltage V2 to power supply voltage V1.

With this, the current value when resistance heater 1 generates heat with predetermined power W can be lowered. Therefore, since resistance value R of resistance heater 1 can be increased, the number of stranded wires included in heater wire 10 can be reduced. Consequently, it is advantageous in that material used for resistance heater 1 can be reduced, and the cost and the weight can be reduced by the amount of the reduced material.

Moreover, in heater control system 100 according to the embodiment, resistance heater 1 is of a single type regardless of a heat generation power specification, and boost voltage V2 is adjusted based on the heat generation power specification of resistance heater 1.

With this, the same resistance heater 1 can support various types of heat generation power specifications. Therefore, it is advantageous in that designing resistance heater 1 according to specifications will not be needed.

### Variations

The following describes variations of heater control system 100 according to the embodiment.

In the embodiment, boost voltage V2 when boost converter 2 performs the boosting operation is a constant voltage, but this is not limiting. For example, boost voltage V2 when boost converter 2 performs the boosting operation may vary according to the rated power of resistance heater 1.

In the embodiment, each of the two resistance heaters 1 (cushion heater 11 and back heater 12) is a seat heater provided to a seat, but this is not limiting. For example, resistance heater 1 may be provided to one or more armrests of a seat, or steering.

In the embodiment, two resistance heaters 1 are provided, but this is not limiting. For example, three or more resistance heaters 1 may be provided, or only one resistance heater 1 may be provided.

In the embodiment, each of resistance heaters 1 is a wire heater, but this is not limiting. For example, resistance heater 1 may be a planar heater.

In the embodiment, boost converter 2 is not limited to the configuration that includes two switching elements, which are first switching element SW1 and second switching element SW2. For example, boost converter 2 may have a configuration that includes only one switching element (first switching element SW1) and a diode instead of second switching element SW2. In this case, a switching element such as FET 202 may be provided between positive electrode 31 of power source 3 and boost converter 2 and implement the stopping operation of boost converter 2 by turning off the switching element.

In the embodiment, controller 21 controls each of resistance heaters 1 by executing a series of processes as illustrated in FIG. 4 by software, but this is not limiting. For example, controller 21 may implement the series of processes as illustrated in FIG. 4 by hardware.

In the embodiment, resistance heater 1 has resistance value R that increases as boost ratio K increases, but the configuration of resistance heater 1 is not limited to the configuration in which the material used for resistance heater 1 is reduced in order to increase resistance value R. For example, the length of resistance heater 1 may be increased to increase resistance value R, thereby expanding the range of heat generation. In this case, for example, when the predetermined power W is constant and boost ratio K is 2, resistance value R can be increased by four times. Therefore, although the range of heat generation has been only the seating surface and the surface of the backrest of a seat in a conventional configuration without boosting of voltage (boost ratio is 1), the present disclosure can expand the range of heat generation to a side portion of a seat even when the same power as the conventional configuration is used.

The scope of the present disclosure may also include embodiments as a result of adding various modifications, which may be conceived by those skilled in the art, to the embodiment described above, and embodiments obtained by combining structural elements and functions in the embodiment in any manner as long as the combination does not depart from the spirit of the present disclosure.

While various embodiments have been described herein above, it is to be appreciated that various changes in form and detail may be made without departing from the spirit and scope of the present disclosure as presently or hereafter claimed.

Further Information about Technical Background to this Application

The disclosures of the following patent applications including specification, drawings, and claims are incorporated herein by reference in their entirety: Japanese Patent Application No. 2021-156945 filed on Sep. 27, 2021, Japanese Patent Application No. 2022-069319 filed on Apr. 20, 2022, PCT No. and International Application PCT/JP2022/028870 filed on July 27, 2022.

### INDUSTRIAL APPLICABILITY

The present disclosure can be used, for example, to control a heater that heats a seat, etc. provided in a vehicle.

1. A heater control system comprising:
a resistance heater; and
a boost converter that is electrically connected to the resistance heater, wherein
the boost converter outputs, to the resistance heater, a boost voltage that is higher than a power supply voltage of a power source that is electrically connected to the boost converter.

2. The heater control system according to claim 1, wherein the boost voltage is at least two times the power supply voltage.

3. The heater control system according to claim 1, further comprising:
a temperature detector that detects a temperature of the resistance heater, wherein
the boost converter controls the boost voltage based on a temperature detected by the temperature detector.

4. The heater control system according to claim 3, wherein
when the temperature detected by the temperature detector exceeds a first threshold temperature, the boost converter stops outputting of the boost voltage to the resistance heater, and
when the temperature detected by the temperature detector falls below a second threshold temperature that is lower than the first threshold temperature, the boost converter starts the outputting of the boost voltage to the resistance heater.

5. The heater control system according to claim 4, wherein
the boost converter includes:
an inductance element electrically connected to a positive electrode of the power source;
a first switching element electrically connected between the inductance element and a negative electrode of the power source;
a second switching element electrically connected between the inductance element and the resistance heater; and
a controller that controls on and off of the first switching element and the second switching element, wherein
the controller keeps both the first switching element and the second switching element off to stop the outputting of the boost voltage to the resistance heater.

6. The heater control system according to claim 4, wherein
the temperature detector operates based on the power supply voltage, and
first wiring that connects the temperature detector and the boost converter and second wiring that connects the boost converter and the resistance heater belong to mutually different systems.

7. The heater control system according to claim 1, wherein
the resistance heater includes a sewed heater wire including a plurality of stranded wires.

8. The heater control system according to claim 1, wherein
the resistance heater has a resistance value that increases as a boost ratio increases, the boost ratio being a ratio of the boost voltage to the power supply voltage.

9. The heater control system according to claim 1, wherein
the resistance heater is of a single type regardless of a heat generation power specification, and
the boost voltage is adjusted based on the heat generation power specification of the resistance heater.
